(19) United States
(12) Patent Application Publication
(10) Pub. No.: US 2017/0293656 A1
(43) Pub. Date: Oct. 12, 2017

(54) PROJECTIONS DETERMINATION FOR COLUMN-BASED DATABASES

(71) Applicant: HEWLETT PACKARD ENTERPRISE DEVELOPMENT LP, Huoston, TX (US)

(72) Inventors: Satwant KAUR, Mountain View, CA (US); Larry SCHMIDT, Rutledge, GA (US)

(73) Assignee: HEWLETT PACKARD ENTERPRISE DEVELOPMENT LP, Huoston, TX (US)

(21) Appl. No.: 15/510,610

(22) PCT Filed: Oct. 31, 2014
(86) PCT No.: PCT/US14/63531

§ 371 Date: Mar. 10, 2017

(51) Int. Cl. G06F 17/30

(52) U.S. Cl. CPC G06F 17/30469

(57) ABSTRACT

The present subject matter relates to determining a set of projections for optimizing query execution on a column-based database. In an example implementation, a plurality of historical queries executed on the column-based database is obtained, and the set of projections is determined based on the plurality of historical queries. The set of projections is determined in a manner such that a total cost of the plurality of historical queries over the set of projections is minimum. The total cost is a sum of a cost of each of the plurality of historical queries. The cost of each historical query is computed based on number of columns in a smallest projection from the set of projections which is used for execution of the respective historical query.

### BACKGROUND

Column-based databases, also referred to as column-oriented databases, are the databases in which data is stored in columnar manner. In columnar manner storage, the data associated with the same attribute are tabulated and stored as columns of a table, instead of as rows of a table. A query when executed against a column-based database may use a projection for query execution. The projection projects one or more columns of the column-based database which may be used by the query for its execution. With the use of a projection, the columns projected by the corresponding projection are read from the column-based database, instead of the entire column-based database, for query execution. This facilitates in reducing the run-time of the query over the column-based database.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1(a) illustrates a network environment implementing a projection determination system, according to an example of the present subject matter.

FIG. 1(b) illustrates a projection determination system, according to an example of the present subject matter.

FIG. 2 illustrates the projection determination system, according to an example of the present subject matter.

FIG. 3 illustrates a method of determining a set of projections for a column-based database, according to an example of the present subject matter.

FIG. 4 illustrates a method of iteratively finding and adding a new projection to update the set of projections in an iteration, according to an example of the present subject matter.

FIGS. 5(a) and 5(b) illustrate network environments for determining a set of projections for a column-based database, according to an example of the present subject matter.

### DETAILED DESCRIPTION

Systems and methods of determining a set of projections for optimizing query execution on a column-based database are described herein. Projections are generally used for execution of queries on a column-based database that stores data in a column-wise manner. A projection projects one or more columns of the column-based database, in some implementations in a specific order, which can be used for execution of a query on the column-based database. The projections are updated dynamically as the data in the columns of the column-based database changes. The query execution may be optimized by minimizing the run-time of the queries over the projections associated with the queries. The run-time of a query may depend on the number of columns projected by the projection associated with the query, which are used for the execution of the query. The run-time of the query is also referred to as the cost, i.e., the computational cost of the query.

A user of a column-based database may provide a set of queries for execution on the column-based database. Projections corresponding to the set of queries may be created manually by the user, or generated automatically by a database system, based on the queries provided by the user. In the manual creation of a projection for a query, one or more columns of the column-based database which can be used for execution of the query may be selected by the user. The selection column(s) are associated with a projection, and are said to be projected by the projection during the execution of the query. If the queries provided by the user are large in number, then the effort and time spent for creation of projections is substantially large.

Further, whether done manually by the user or automatically by the database system, the projections are created or generated on a query-by-query basis, i.e., a projection for one query, then another projection for another query, and so on. With this, the run-time of the queries may be reduced at an individual query level and not at the aggregate level over all the queries. Thus, the execution of the set of queries provided by the user may not be optimum, as the aggregate run-time of the set of queries may not be a minimum.

Further, the database system generally has a limit on the maximum number of projections that can be created or generated for query execution. Thus, when projections are created or generated on the query-by-query basis, the number of queries that can be assessed is limited by the maximum number of projections. This affects optimizing the execution of queries, when the queries provided by the user are more than the maximum number of projections that can be created or generated for query execution.

The present subject matter relates to systems and methods of determining a set of projections for optimizing query execution on a column-based database. The set of projections is determined automatically without a manual intervention, enabling minimization of the aggregate run-time or cost of multiple queries, when executed on the column-based database. The aggregate run-time or cost is also referred to as the total run-time or cost.

In accordance with the present subject matter, the set of projections is determined based on a plurality of historical queries that have already been executed on the column-based database. The set of projections is determined such that a total cost or a total run-time of the plurality of historical queries over the set of projections is a minimum. The set of projections determined based on the plurality of historical queries facilitates in faster evaluation of future queries that are structurally similar to the historical queries based on which the set of projections is determined. The future queries may be understood as queries provided by a user, from time to time, for execution on the column-based database. With this, the evaluation of future queries, similar to the historical queries, can be optimized.

With the systems and the methods of the present subject matter, the set of projections are determined at an aggregated level over the plurality of historical queries, and not at an individual query level. With this, the aggregate run-time of queries, i.e., the future queries, can be optimized to a minimum, even if the number of future queries are more than the maximum number of projections that can be determined for query evaluation.

The system, in accordance with the present subject matter, may be a database system. The database system may be a computing device having a column-based database. The database system may include, but is not limited to, a server, a desktop computer, a laptop, and the like.

In an example implementation of the present subject matter, a plurality of historical queries that are executed on a column-based database is obtained. Based on the plurality of historical queries, a set of projections is determined, such that a total cost of the plurality of historical queries over the set of projections is minimum. Here, the total cost is computed based on a sum of cost of each historical query, where the cost of each historical query is computed based on number of columns in a smallest projection from the set of projections which is used for execution of the respective historical query.

For determining the set of projections, in an example implementation, the set of projections is created by initially adding a super projection to the set of projections. The super projection is a projection that projects all the columns of the column-based database. Then, new projections are iteratively found and added to update the set of projections, where each new projection is a projection that minimizes a total cost of the plurality of historical queries over the updated set of projections for the respective iteration. In an iteration, the cost of each historical query is computed based on number of columns in a smallest projection from the updated set of projections for that iteration, which is used for the execution of the respective historical query. The new projections are iteratively found and added until the set of projections has a predefined maximum number of projections or the total cost of the plurality of projections over the updated set of projections is unchanged for two consecutive iterations.

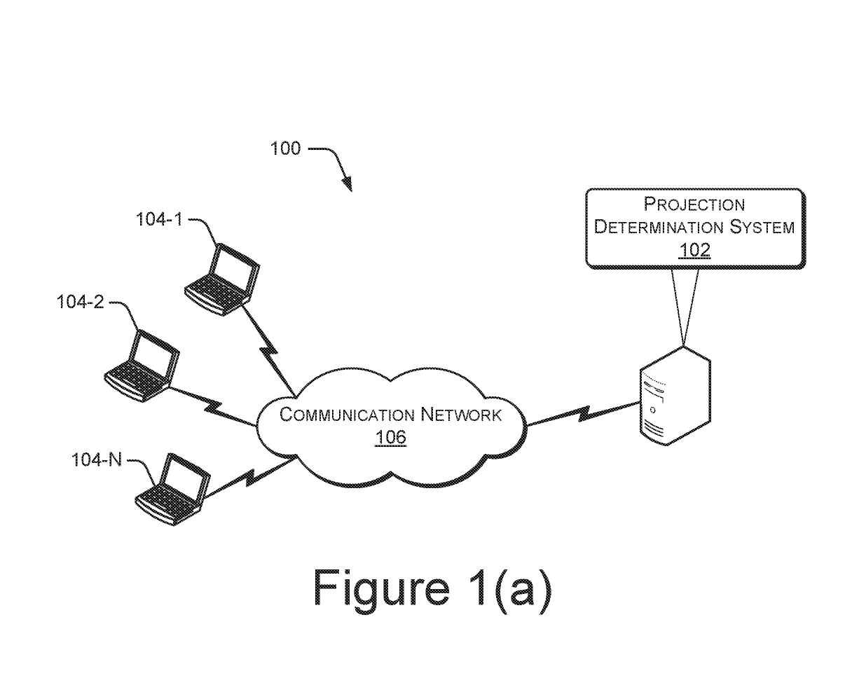

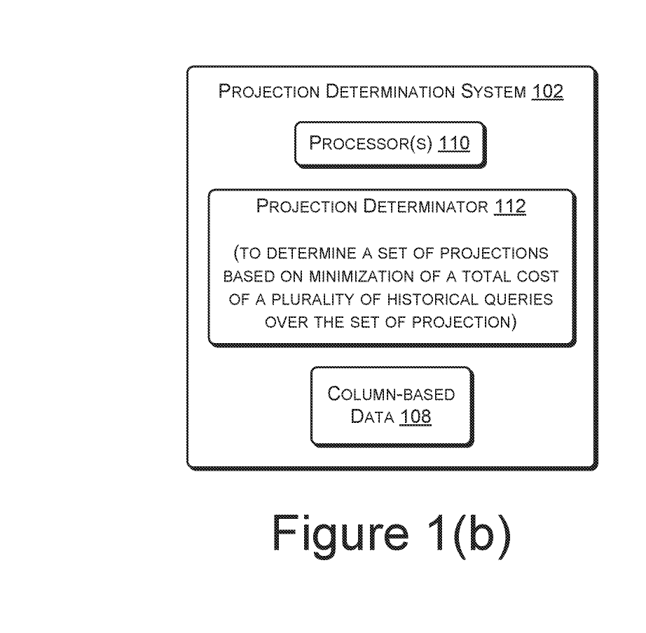

The above methods and systems are further described with reference to FIGS. 1 to 5. It should be noted that the description and figures merely illustrate the principles of the present subject matter. It is thus understood that various implementations can be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1(a) schematically illustrates a network environment 100 implementing a projection determination system 102, according to an example of the present subject matter. The network environment 100 may be a public network environment or a private network environment. The projection determination system 102 may be a computer-readable instructions-based implementation or a hardware-based implementation or a combination thereof. The projection determination system 102 described herein can be implemented in a database system. The database system may be a computing device, such as a server, a laptop, a desktop computer, and the like, having a column-based database. In an example implementation, the projection determination system 102 may be implemented in a computing device that communicates with an external database system having a column-based database. The projection determination system 102 enables the determination of a set of projections, in accordance with the present subject matter, for optimizing query execution on the column-based database of the database system.

As shown in FIG. 1(a), the network environment 100 includes a plurality of user devices 104-1, 104-2, . . . , 104-N through which users can provide queries for execution on the column-based database based on the set of projections determined by the projection determination system 102. The plurality of user devices 104-1, 104-2, . . . , 104-N may include, but is not restricted to, a laptop, a desktop computer, a personal digital assistant, and the like. The plurality of user devices 104-1, 104-2, . . . , 104-N may collectively be referred to as user devices 104, and individually be referred to as a user device 104.

Further, as shown in FIG. 1(a), the projection determination system 102 and the user devices 104 may be communicatively coupled to each other through a communication network 106. In an example, the projection determination system 102 may be directly coupled to one or more of the user devices 104. In an example, the projection determination system 102 can communicate with the user devices 104 for the purpose of determination of the set of projections, in accordance with the present subject matter, and for execution of queries based on the determined set of projections.

In an example implementation, the projection determination system 102 and the user devices 104 may be communicatively coupled over the communication network 106 through one or more communication links. The communication links are enabled through a desired form of communication, for example, via dial-up modem connections, cable links, and digital subscriber lines (DSL), wireless or satellite links, or any other suitable form of communication. The communication network 106 may be a wireless network, a wired network, or a combination thereof. The communication network 106 can also be an individual network or a collection of many such individual networks, interconnected with each other and functioning as a single large network, e.g., the Internet or an intranet. The communication network 106 can be implemented as one of the different types of networks, such as intranet, local area network (LAN), wide area network (WAN), and the internet. The communication network 106 may either be a dedicated network or a shared network, which represents an association of the different types of networks that use a variety of protocols, for example, Hypertext Transfer Protocol (HTTP), and Transmission Control Protocol/Internet Protocol (TCP/IP), to communicate with each other.

FIG. 1(b) illustrates the projection determination system 102, according to an example of the present subject matter. The projection determination system 102 includes column-based data 108 of the database system in which the projection determination system 102 is implemented. The column-based data 108 stores the data in form of columns of a table. Although shown inside the projection determination system 102, in an example implementation, the column-based data 108 may be a part of an external database system, and the projection determination system 102 may communicate with the external database system for determination of the set of projections for query execution.

Further, as shown in FIG. 1(b), the projection determination system 102 includes processor(s) 110. The processor(s) 110 may be implemented as microprocessors, microcomputers, microcontrollers, digital signal processors, central processing units, state machines, logic circuitries, and/or any devices that manipulate signals based on operational instructions. Among other capabilities, the processor(s) 110 fetch and execute computer-readable instructions stored in a memory of the projection determination system 102. The functions of the various elements shown in FIG. 1(b), including any functional blocks labeled as “processor(s)”, may be provided through the use of dedicated hardware as well as hardware capable of executing computer-readable instructions.

As shown in FIG. 1(b), the projection determination system 102 includes a projection determinator 112. The projection determinator 112 is coupled to the processor(s) 110 to determine a set of projections based on minimization of a total cost of a plurality of historical queries over the set of projections. The determined set of projections facilitates faster execution of future queries provided by a user using a user device 104, which are structurally similar to the plurality of historical queries used for determining the set of projections.

The description hereinafter describes, in detail, the procedure of determining the set of projections for a column-based database using the projection determination system 102, in accordance with an example implementation.

In an example implementation, the projection determinator 112 obtains a plurality of historical queries executed on the column-based database. The projection determinator 112 may obtain the plurality of historical queries executed on the column-based database for a predefined historical time period. For example, the queries executed in last fortnight, last one week, or last three days, or the like, may be obtained by the projection determinator 112. The predefined historical time period for which the historical queries are obtained may be set or varied by a database administrator.

After obtaining the plurality of historical queries, the projection determinator 112 determines a set of projections, such that a total cost of the plurality of historical queries over the set of projections is minimum. The total cost may also be referred to as the total run-time of the plurality of historical queries. The total cost of the plurality of historical queries is computed as a sum of the cost of each historical query over the set of projections. The cost of a query is governed by the run-time of the query. The run-time of the query is dependent on the number of columns projected by a projection which are used to execute the query. The fewer the number of columns in the projection used, the faster is the query execution, and the lesser is the run-time.

To determine the set of projections, the projection determinator 112 creates a set of projections by initially adding a super projection to the set of projections. The super projection is a projection that projects all the columns of the column-based database. The projection determinator 112 may compute the total cost of the plurality of historical queries over this set of projections. With the set of projections having only the super projection initially, the cost of each historical query is computed as equal to the number of columns in the super projection.

After this, the projection determinator 112 iteratively finds and adds new projections to update the set of projections in a manner such that each new projection in the respective iteration minimizes the total cost of the plurality of historical queries over the updated set of projections for the respective iteration. In an iteration, the cost of one historical query is computed as the number of columns of the smallest projection from the set of projections updated in the iteration, which is used for execution of that historical query.

To explain this in detail, consider the first iteration in which the first new projection is found and added to update the set of projections which previously has the super projection only. The cost of a historical query over the set of projections with the super projection and the first new projection is computed as the number of columns of the smaller projection, out of the super projection and the first new projection, which has the columns for executing that historical query. Similarly, consider the second iteration in which the second new projection is found and added to update the set of projections, wherein the set previously has the super projection and the first new projection. The cost of a historical query over this updated set of projections is computed as the number of columns of the smallest projection, out of the super projection, the first new projection, and the second new projection, which has the columns for executing that historical query. Based on the above description, for example, at the second iteration, the updated set of projections has the super projection with 100 columns, the first new projection with 40 columns, and the second new projection with 30 columns. If the second new projection has the columns for executing a historical query, then the cost of that historical query over the set of projections is 30. If, instead, the first new projection has the columns for executing a historical query, then the cost of the historical query is 40.

In an example implementation, the projection determinator 112 iteratively finds and adds the new projections to update the set of projections until the set of projections has a predefined maximum number of projections, or the total cost of the plurality of historical queries is unchanged for two consecutive iterations. In an example, the predefined maximum number of projections may be set or varied by the database administrator of the column-based database.

The description hereinafter describes, in detail, the procedure to find and add one new projection to update the set of projections in one iteration by the projection determinator 112, according to an example implementation. The same procedure is iteratively repeated to find and add the new projections in the set until one of the above described conditions is met.

In an example implementation, for finding and adding a new projection in an iteration, the projection determinator 112 may generate projections that project up to k columns of the column-based database. Herein, k is an integer and is equal to at least two. In an example, if k is equal to three, then all the projections that project one column, project two columns, and project three columns, of the column-based database may be generated by the projection determinator 112. After generating such projections, the projection determinator 112 may select a projection from the generated projections, which, when added to the set of projections determined after a previous iteration, minimizes the total cost of the plurality of historical queries over the set of projections.

After selecting a projection, the projection determinator 112 may generate modified projections by adding up to k columns of the column-based database to the selected projection. In an example with k equal to three, if the selected projection has two columns, then the modified projections are generated by adding one column, two columns, and three columns, of the column-based database to the selected projection of two columns.

After generating the modified projections, the projection determinator 112 may select a projection from the modified projections, which, when added to the set of projections, minimizes the total cost of the plurality of historical queries over the set of projections.

The projection determinator 112 may continue to iteratively generate subsequent modified projections by adding up to k columns of the column-based database to the projection selected from the previously modified projections, and select a subsequent projection from the subsequent modified projections, which, when added to the set of projections, minimizes the total cost of the plurality of historical queries over the set of projections. The subsequent modified projections are iteratively generated and the subsequent projection is selected until the total cost in an iteration is more than or equal to the total cost of the plurality of historical queries over the set of projections in a previous iteration. The projection selected from a last iteration is then the new projection which is added to update the set of projections.

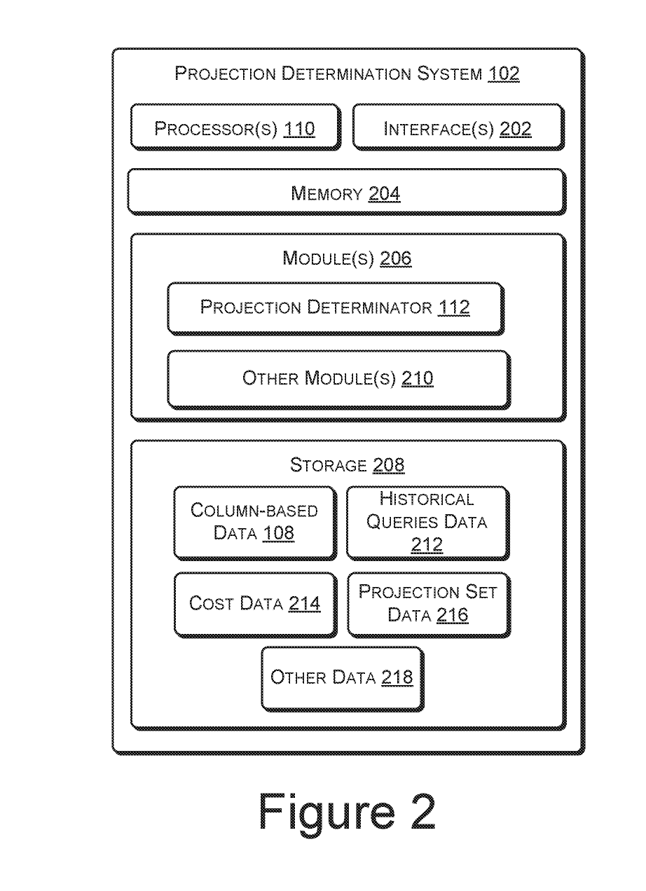

FIG. 2 illustrates the projection determination system 102, according to an example of the present subject matter. The projection determination system 102 includes the processor(s) 110 and also interface(s) 202. The interface(s) 202 may include a variety of computer-readable instruction-based and hardware interfaces that allow the projection determination system 102 to interact with the user devices 104, external database systems, and other devices or components in the network environment 100.

Further, the projection determination system 102 includes memory 204, coupled to the processor(s) 110. The memory 204 may include any computer-readable medium including, for example, volatile memory (e.g., RAM), and/or non-volatile memory (e.g., EPROM, flash memory, NVRAM, memristor, etc.).

Further, the projection determination system 102 includes module(s) 206 and storage 208 coupled to the processor(s) 110. The module(s) 206, amongst other things, include routines, programs, objects, components, data structures, and the like, which perform particular tasks or implement particular abstract data types. The module(s) 206 further include modules that supplement applications on the projection determination system 102, for example, modules of an operating system.

The module(s) 206 of the projection determination system 102 includes the projection determinator 112 and other module(s) 210. The other module(s) 210 may include programs or coded instructions that supplement applications and functions, for example, programs in the operating system of the projection determination system 102.

Further, the storage 208 of the projection determination system 102 serves, amongst other things, as a repository for storing data that may be fetched, processed, received, or generated by the module(s) 206. Although the storage 208 is shown internal to the projection determination system 102, it may be understood that the storage 208 can reside in an external repository (not shown in the figure), which may be coupled to the projection determination system 102. The projection determination system 102 may communicate with the external repository through the interface(s) 202 to obtain information from the storage 208.

In an example implementation, the storage 208 of the projection determination system 102 includes the column-based data 108, historical queries data 212, cost data 214, projection set data 216, and other data 218. The other data 218 comprises data corresponding to other module(s) 210.

In an example implementation, the historical queries executed on the column-based database may be stored in the historical queries data 212, and the projection determinator 112 may obtain the plurality of historical queries from the historical queries data 212. The cost of each historical query and the total cost of the plurality of historical queries may be stored in the cost data 214.

In an example implementation, the set of projections generated by the projection determination system 102 may be stored in the projection set data 216. The set of projections can then be utilized for execution of future queries on the column-based database. The set of projections can result in an increase in the speed of execution of the future queries that are structurally similar to the plurality of historical queries based on which the set of projections is generated.

In an example implementation, the new queries that are provided by a user and are executed on the column-based database may be stored to update the historical queries data 212. The updating of the historical queries data 212 may be in real-time.

In an example implementation, the projection determination system 102 may periodically perform the above described procedure to revise the set of projections based on the updated historical queries.

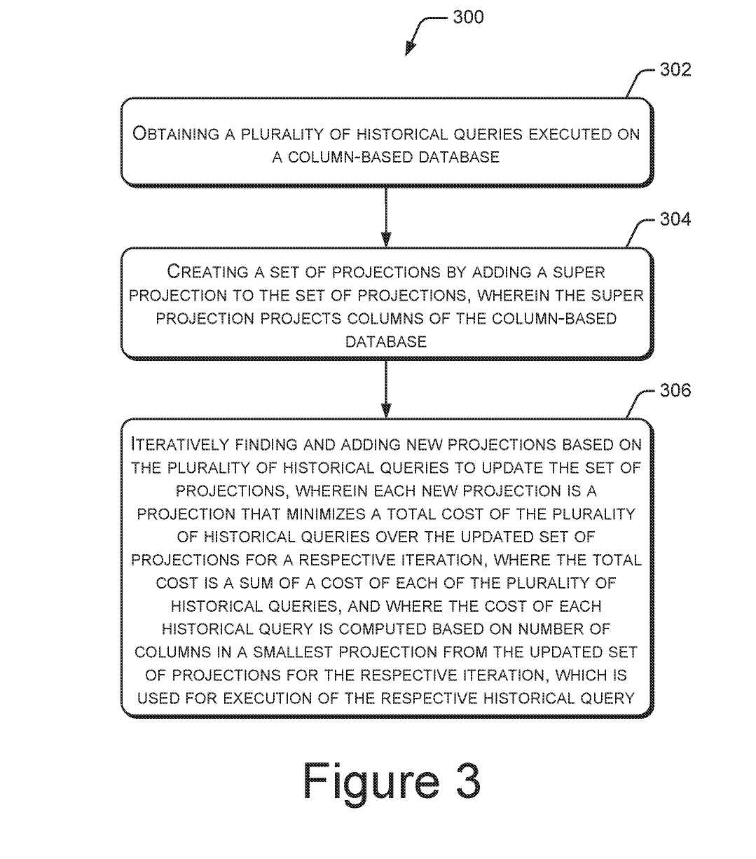

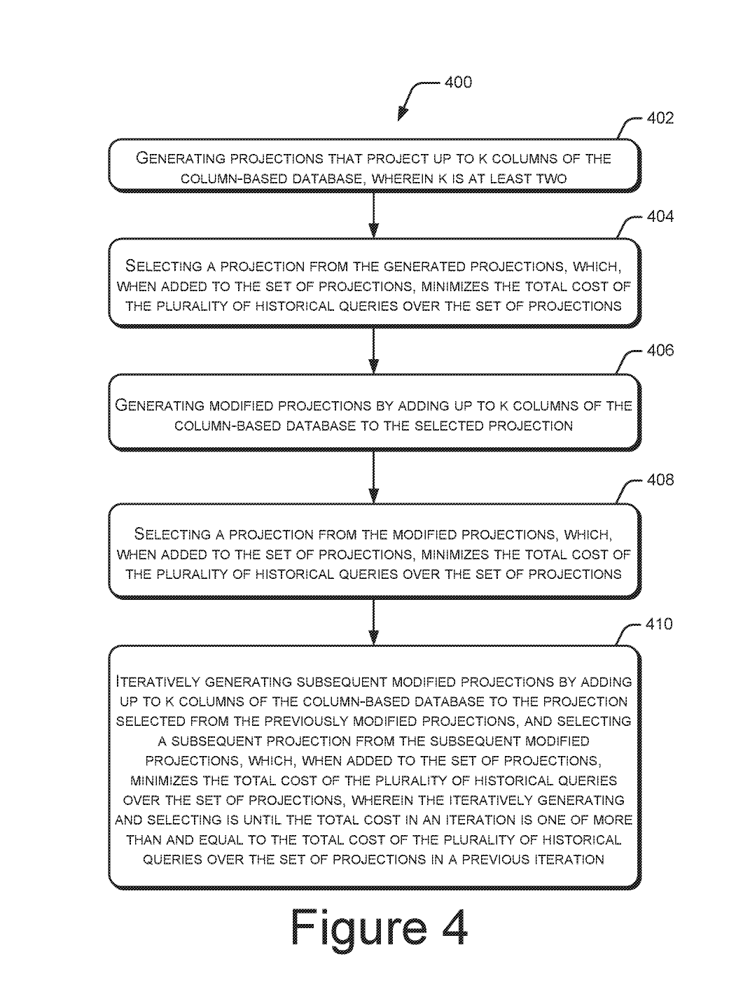

FIG. 3 illustrates a method 300 of determining a set of projections for a column-based database, according to an example of the present subject matter. FIG. 4 illustrates a method 400 of iteratively finding and adding a new projection to update the set of projections in an iteration, according to an example of the present subject matter. The order in which the methods 300, 400 are described is not intended to be construed as a limitation, and any number of the described method blocks can be combined in any order to implement the methods 300, 400, or an alternative method. Furthermore, the methods 300, 400 can be implemented by processor(s) or computing device(s) through any suitable hardware, non-transitory computer-readable instructions, or combination thereof.

It may be understood that steps of the methods 300, 400 can be performed by programmed computing devices. The steps of the methods 400 can be executed based on instructions stored in a non-transitory computer-readable medium, as will be readily understood. The non-transitory computer-readable medium may include, for example, digital memories, magnetic storage media, such as a magnetic disks and magnetic tapes, hard drives, or optically readable digital data storage media.

Further, although the methods 300, 400 may be implemented in a variety of computing devices working in different network environments; in the example implementations described in FIG. 3 and FIG. 4, the methods 300, 400 are explained in context of the aforementioned projection determination system 102 in the network environment 100, for ease of explanation.

Referring to FIG. 3, at block 302, a plurality of historical queries executed on the column-based database is obtained. The plurality of historical queries may refer to the queries that have been executed on the column-based database. The plurality of historical queries executed on the column-based database for a predefined historical time period may be obtained. For example, the queries executed in last fortnight, last one week, or last three days, or the like, may be obtained. The plurality of historical queries is obtained by the projection determination system 102.

At block 304, a set of projections is created by adding a super projection to the set of projections, where the super projection projects columns of the column-based database. The set of projections is created by the projection determination system 102.

At block 306, new projections are iteratively found based on the plurality of historical queries and added to update the set of projections. Herein, each new projection is a projection that minimizes a total cost of the plurality of historical queries over the updated set of projections for a respective iteration. The total cost is a sum of a cost of each of the plurality of historical queries, where the cost of each historical query is computed based on number of columns in a smallest projection from the updated set of projections for the respective iteration, which is used for execution of the respective historical query. The new projections are iteratively found and added by the projection determination system 102. The procedure to find and add one new projection in an iteration is described with reference to the method 400 illustrated in FIG. 4.

Referring to FIG. 4, at block 402, projections that project up to k columns of the column-based database are generated, where k is at least two. At block 404, a projection is selected from the generated projections, which, when added to the set of projections, minimizes the total cost of the plurality of historical queries over the set of projections. After this, at block 406, modified projections are generated by adding up to k columns of the column-based database to the selected projection. At block 408, a projection is selected from the modified projections, which, when added to the set of projections, minimizes the total cost of the plurality of historical queries over the set of projections.

At block 410, subsequent modified projections are iteratively generated by adding up to k columns of the column-based database to the projection selected from the previously modified projections, and a subsequent projection is iteratively selected from the subsequent modified projections, which, when added to the set of projections, minimizes the total cost of the plurality of historical queries over the set of projections. The iterative generation and selection are until the total cost in an iteration is one of more than and equal to the total cost of the plurality of historical queries over the set of projections in a previous iteration. The projection selected from a last iteration is thus the new projection to update the set of projections.

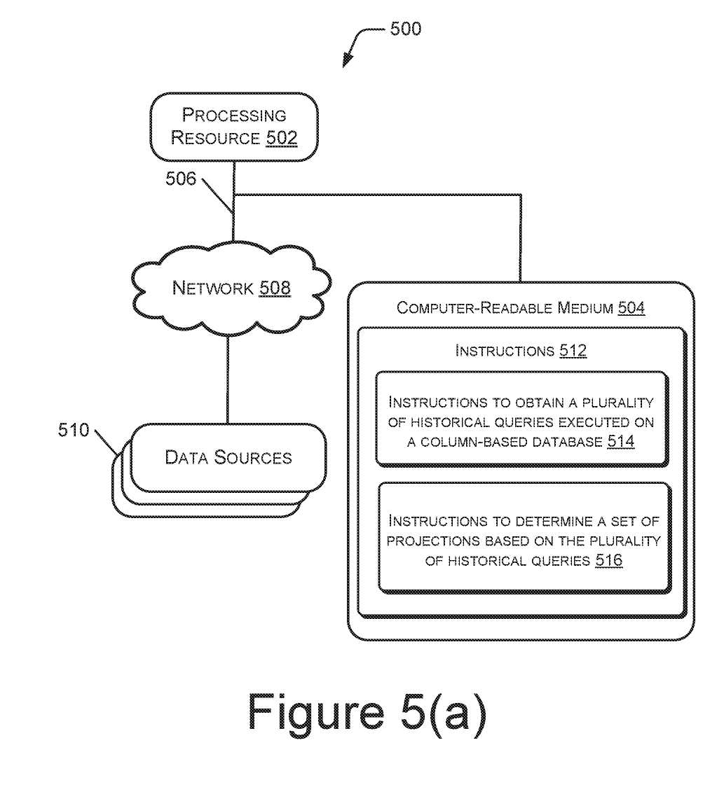

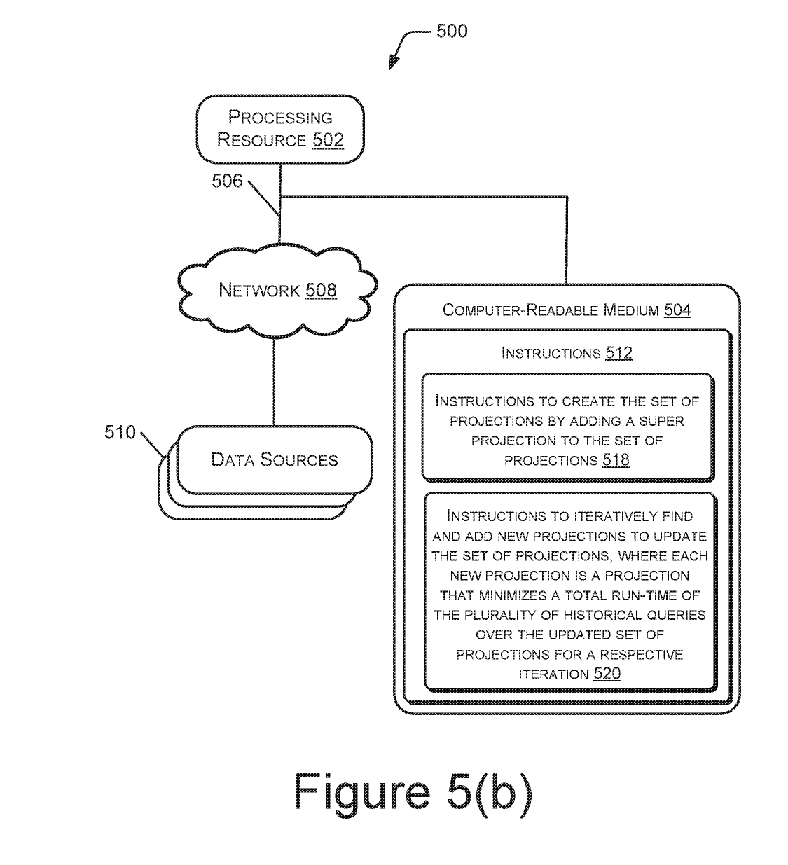

FIGS. 5(a) and 5(b) illustrate network environments 500 implementing a non-transitory computer-readable medium for determining a set of projections for a column-based database, according to an example of the present subject matter. The network environment 500 may be a public networking environment or a private networking environment. In an example implementation, the network environment 500 includes a processing resource 502 communicatively coupled to a non-transitory computer-readable medium 504 through a communication link 506.

For example, the processing resource 502 can be a processor of a database system, such as a server or a computer, which has a column-based database. In an example, the processing resource 502 may be a processor of the projection determination system 102. The non-transitory computer-readable medium 504 can be, for example, an internal memory device or an external memory device. In an example implementation, the communication link 506 may be a direct communication link, such as any memory read/write interface. In another example implementation, the communication link 506 may be an indirect communication link, such as a network interface. In such a case, the processing resource 502 can access the non-transitory computer-readable medium 504 through a network 508. The network 508 may be a single network or a combination of multiple networks and may use a variety of different communication protocols.

The processing resource 502 and the non-transitory computer-readable medium 504 may also be communicatively coupled to data sources 510 over the network 508. The data sources 510 can include, for example, user devices through which users can provide queries for execution on the column-based database.

In an example implementation, the non-transitory computer-readable medium 504 includes a set of computer-readable instructions for determining a set of projections for a column-based database. The set of computer-readable instructions, referred to as instructions 512 hereinafter, can be accessed by the processing resource 502 through the communication link 506 and subsequently executed to perform acts for determining the set of projections for the column-based database.

Referring to FIG. 5(a), in an example, the instructions 512 include instructions 514 that cause the processing resource 502 to obtain a plurality of historical queries executed on a column-based database. The plurality of historical queries may include queries that have been executed on the column-based database over a predefined historical time period.

The instructions 512 also includes instructions 516 that cause the processing resource 502 to determine a set of projections based on the plurality of historical queries. The set of projections are determined such that a total run-time of the plurality of historical queries over the set of projections is minimum. The total run-time may also be referred to as the total cost of the plurality of historical queries. The total run-time is a sum of a run-time of each of the plurality of historical queries, where the run-time of each historical query is computed based on number of columns in a smallest projection from the set of projections which is used for execution of the respective historical query.

Referring to FIG. 5(b), the instructions 512 may further include instructions 518 that cause the processing resource 502 to create the set of projections by adding a super projection to the set of projections. The super projection projects all the columns of the column-based database. The instructions 512 may further include instructions 520 that cause the processing resource 502 to iteratively find and add new projections to update the set of projections. The new projections are iteratively found and added in a manner such that each new projection minimizes a total run-time of the plurality of historical queries over the updated set of projections for a respective iteration. The run-time of each historical query is computed based on number of columns in a smallest projection from the updated set of projections for the respective iteration, which is used for execution of the respective historical query.

In an example implementation, to iteratively find and add a new projections in an iteration, the instructions 512 may further include instruction that cause the processing resource 502 to generate projections that project up to k columns of the column-based database, where k is at least two, and then select a projection from the generated projections, which, when added to the set of projections, minimizes the total run-time of the plurality of historical queries over the set of projections. After this, the instructions 512 may cause the processing resource 502 to generate modified projections by adding up to k columns of the column-based database to the selected projection, select a projection from the modified projections, which, when added to the set of projections, minimizes the total run-time of the plurality of historical queries over the set of projections. The subsequent modified projections are iteratively generated by adding up to k columns of the column-based database to the projection selected from the previously modified projections, and a subsequent projection is iteratively selected from the subsequent modified projections, which, when added to the set of projections, minimizes the total run-time of the plurality of historical queries over the set of projections. The iterative generation and selection are until the total run-time in an iteration is one of more than and equal to the total run-time of the plurality of historical queries over the set of projections in a previous iteration. The projection selected from a last iteration is thus the new projection to update the set of projections.

Although implementations for determining a set of projections for optimizing query execution on a column-based database have been described in language specific to structural features and/or methods, it is to be understood that the present subject matter is not necessarily limited to the specific features or methods described. Rather, the specific features and methods are disclosed and explained as example implementations for determining a set of projections for optimizing query execution on a column-based database.

We claim:

1. A projection determination system for determining a set of projections for optimizing query execution on a column-based database, wherein each projection in the set of projections projects one or more columns of the column-based database for query execution, the projection determination system comprising:
a processor; and
a projection determinator coupled to the processor to,
obtain a plurality of historical queries executed on the column-based database; and
determine the set of projections based on the plurality of historical queries, wherein a total cost of the plurality of historical queries over the set of projections is minimum, wherein the total cost is a sum of a cost of each of the plurality of historical queries, and wherein the cost of each historical query is computed based on number of columns in a smallest projection from the set of projections which is used for execution of the respective historical query.

2. The projection determination system as claimed in claim 1, wherein the projection determinator is coupled to the processor to,
create the set of projections by adding a super projection to the set of projections, wherein the super projection projects columns of the column-based database; and
iteratively find and add new projections to update the set of projections, wherein each new projection is a projection that minimizes a total cost of the plurality of historical queries over the updated set of projections for a respective iteration, and wherein the cost of each historical query is computed based on number of columns in a smallest projection from the updated set of projections for the respective iteration, which is used for execution of the respective historical query.

3. The projection determination system as claimed in claim 2, wherein the new projections are iteratively found and added until the set of projections has a predefined maximum number of projections.

4. The projection determination system as claimed in claim 2, wherein the new projections are iteratively found and added until the total cost of the plurality of historical queries over the updated set of projections is unchanged for two consecutive iterations.

5. The projection determination system as claimed in claim 2, wherein the projection determinator is coupled to the processor to, in each iteration,
generate projections that project up to k columns of the column-based database, wherein k is at least two;
select a projection from the generated projections, which, when added to the set of projections, minimizes the total cost of the plurality of historical queries over the set of projections;
generate modified projections by adding up to k columns of the column-based database to the selected projection;
select a projection from the modified projections, which, when added to the set of projections, minimizes the total cost of the plurality of historical queries over the set of projections; and
iteratively generate subsequent modified projections by adding up to k columns of the column-based database to the projection selected from the previously modified projections, and select a subsequent projection from the subsequent modified projections, which, when added to the set of projections, minimizes the total cost of the plurality of historical queries over the set of projections,
wherein the subsequent modified projections are iteratively generated and the subsequent projection is selected until the total cost in an iteration is one of more than and equal to the total cost of the plurality of historical queries over the set of projections in a previous iteration, wherein the projection selected from a last iteration is the new projection to update the set of projections.

6. The projection determination system as claimed in claim 1, wherein the plurality of historical queries comprises queries executed on the column-based database for a predefined historical time period.

7. A method of determining a set of projections for optimizing query execution on a column-based database, wherein each projection in the set of projections projects one or more columns of the column-based database for query execution, the method comprising:
obtaining a plurality of historical queries executed on the column-based database;
creating the set of projections by adding a super projection to the set of projections, wherein the super projection projects columns of the column-based database; and
iteratively finding and adding new projections based on the plurality of historical queries to update the set of projections, wherein each new projection is a projection that minimizes a total cost of the plurality of historical queries over the updated set of projections for a respective iteration, and wherein the total cost is a sum of a cost of each of the plurality of historical queries, and wherein the cost of each historical query is computed based on number of columns in a smallest projection from the updated set of projections for the respective iteration, which is used for execution of the respective historical query.

8. The method as claimed in claim 7, wherein the iteratively finding and adding the new projections are until the set of projections has a predefined maximum number of projections.

9. The method as claimed in claim 7, wherein the iteratively finding and adding the new projections are until the total cost of the plurality of historical queries over the updated set of projections is unchanged for two consecutive iterations.

10. The method as claimed in claim 7, wherein the iteratively finding and adding the new projection, in each iteration, comprises:
generating projections that project up to k columns of the column-based database, wherein k is at least two;
selecting a projection from the generated projections, which, when added to the set of projections, minimizes the total cost of the plurality of historical queries over the set of projections;
generating modified projections by adding up to k columns of the column-based database to the selected projection;
selecting a projection from the modified projections, which, when added to the set of projections, minimizes the total cost of the plurality of historical queries over the set of projections; and
iteratively generating subsequent modified projections by adding up to k columns of the column-based database to the projection selected from the previously modified projections, and selecting a subsequent projection from the subsequent modified projections, which, when added to the set of projections, minimizes the total cost of the plurality of historical queries over the set of projections,
wherein the iteratively generating and selecting are until the total cost in an iteration is one of more than and equal to the total cost of the plurality of historical queries over the set of projections in a previous iteration, wherein the projection selected from a last iteration is the new projection to update the set of projections.

11. The method as claimed in claim 7, wherein the plurality of historical queries comprises queries executed on the column-based database for a predefined historical time period.

12. A non-transitory computer-readable medium comprising computer-readable instructions for determining a set of projections for a column-based database, executable by a processing resource of a projection determination system to:
obtain a plurality of historical queries executed on the column-based database; and
determine the set of projections based on the plurality of historical queries, wherein a total run-time of the plurality of historical queries over the set of projections is minimum, wherein the total run-time is a sum of a run-time of each of the plurality of historical queries, and wherein the run-time of each historical query is computed based on number of columns in a smallest projection from the set of projections which is used for execution of the respective historical query.

13. The non-transitory computer-readable medium as claimed in claim 12 comprising computer-readable instructions executable by the processing resource to:
create the set of projections by adding a super projection to the set of projections, wherein the super projection projects columns of the column-based database; and
iteratively find and add new projections to update the set of projections, wherein each new projection is a projection that minimizes a total run-time of the plurality of historical queries over the updated set of projections for a respective iteration, and wherein the run-time of each historical query is computed based on number of columns in a smallest projection from the updated set of projections for the respective iteration, which is used for execution of the respective historical query.

14. The non-transitory computer-readable medium as claimed in claim 12 comprising computer-readable instructions executable by the processing resource to iteratively find and add the new projections until the set of projections has a predefined maximum number of projections.

15. The non-transitory computer-readable medium as claimed in claim 12 comprising computer-readable instructions executable by the processing resource to iteratively find and add the new projections until the total run-time of the plurality of historical queries over the updated set of projections is unchanged for two consecutive iterations.
